(19) United States
(12) Patent Application Publication
(10) Pub. No.: US 2021/0317003 A1
(43) Pub. Date: Oct. 14, 2021

(54) Preparation method and application of Yb3+-doped high temperature thermistor materials

(71) Applicant: ZKLM New Material (Yangzhou) Co., Ltd., Yangzhou (CN)

(72) Inventors: Li NI, Yangzhou (CN); Mingya LI, Yangzhou (CN); Yang ZHOU, Yangzhou (CN); Yuanwei LIN, Yangzhou (CN); Zhilong FU, Yangzhou (CN)

(21) Appl. No.: 17/304,807

(22) Filed: Jun. 25, 2021

(30) Foreign Application Priority Data
Dec. 31, 2020 (CN) 202011644572.5

(51) Int. Cl. C01G 41/00; H01C 7/04

(52) U.S. Cl. CPC C01G 41/006; H01C 7/043; C01P 2006/32; C01P 2006/40; C01P 2002/54

(57) ABSTRACT

A thermistor material composed of Ca₁₋ₓYbₓCeNbWO₈(0≤x≤0.2) can be used in a wide temperature range from 25 to 800° C. It is made from high-pure CaCO₃, CeO₂, NbO₅, WO₃ and Yb₂O₃. These ceramic materials with a scheelite structure can be obtained after mixing, grinding, calcination, pressing, cold isostatic pressing and high-temperature sintering, etc. The values of material constant B_{300° C./600° C.} and ρ_{25° C.} of thermistor materials are in the range of 6465K-6732K, 4.06×10⁷Ω.cm-8.63×10⁷Ω.cm. The thermistor material has a good thermostability and significant negative temperature coefficient (NTC) characteristic in the temperature range of 25° C. to 800° C., could be used as a potential for fabricating high-temperature thermistor sensors.

This application claims priority to Chinese Patent Application Ser. No. CN202011644572.5 filed on 31 Dec. 2020.

### TITLE OF INVENTION

Preparation method and application of Yb3+-doped high temperature thermistor materials

### BACKGROUND OF INVENTION

This invention relates to the ceramic materials for thermistor, and more particularly to materials for high temperature thermistors.

With the rapid development of science and technology, negative temperature coefficient (NTC) thermistor has been used in many fields, and is closely related to people's life. NTC ceramic material is the core of thermistor and the development of industry and market demand promote the development of NTC thermistor. NTC thermistor materials from low temperature to high temperature applications become more and more urgent in the industrial field, especially in the automobile industry. Therefore, it is of great significance to develop NTC thermistor ceramic materials for high temperature applications.

NTC thermistor has the characteristics of high sensitivity and fast response. However, the traditional Mn—Co—Ni—O spinel thermistor materials are mainly used below 300° C., which brings new challenges to the development of new high temperature thermistor materials.

A preliminary study on the NTC electrical properties of CaCeNbWO₈ thermistor materials prepared via a conventional solid-state reaction method shows that the material constant B of CaCeNbWO₈ is 9600K. However, for the wide range of applications of the thermistors, it is necessary to reduce the B value of CaCeNbWO₈ at high temperature. Considering the ionic radii of Ca²⁺ and Yb³⁺ and high temperature-resistance characteristic of Yb₂O₃, the substitution of Yb³⁺ for Ca²⁺ can generate electrons. In order to maintain electrical neutrality, the generated electrons will be compensated by the conversion of Ce⁴⁺ to Ce³⁺ ions, resulting in an increase in the concentration of Ce³⁺ ions and an increase in the carrier concentration, which in turn leads to a decrease in the B value.

Based on the semiconductivity of CaCeNbWO₈, this invention provides a Ca₁₋ₓYbₓCeNbWO₈ thermistor material having a single scheelite structure that can be used in a wide temperature range from 25 to 800° C.

### SUMMARY OF THE INVENTION

Focusing on the problem of existing technology, an object of the present invention is to provide Yb³⁺-doped high temperature NTC thermistor ceramics. The thermistor ceramics prepared by the invention have stable performance and good consistency. The thermistor material has obvious negative temperature coefficient characteristics in the temperature range of 25° C.-800° C., and it is suitable for manufacturing high temperature thermistor.

Another object of the invention is to provide a preparation method and application of Yb³⁺- doped high temperature NTC thermistor ceramics.

Above objects of the invention are obtained by providing high-temperature thermistor composition according to the present invention, which is composed of Yb₂O₃ doped Ca₁₋ₓYbₓCeNbWO₈(0≤x≤0.2) ceramics.

Especially, the high temperature thermistor material is provided by a composition of Ca₁₋ₓYbₓCeNbWO₈ solid solution, wherein 0<x≤0.2. The structure of the ceramics is CaWO₄ scheelite structure.

Preferably, molar ratio of Ca, Yb, Ce, Nb, W of high temperature thermistor materials is (0.8-1):(0.05-0.2):1:1:1.

More preferably, x=0.2, molar ratio of Ca, Yb, Ce, Nb, W of high temperature thermistor materials is 0.8:0.2:1:1:1.

Said thermistor ceramic materials have obvious negative temperature coefficient characteristics in the temperature range of 25° C.-800° C.

The high-temperature thermistor ceramics according to the invention are prepared as follow.

According to the composition Ca₁₋ₓYbₓCeNbWO₈, appropriate amounts of high-purity Yb₂O₃(99.99%), CaCO₃(99%), CeO₂(99.99%), Nb₂O₅(99.99%), and WO₃(99.99%) are weighted and well mixed to obtain mixed powder.

The mixed powders obtained in the step a are calcined and ground to obtain Ca₁₋ₓYbₓCeNbWO₈ powder.

The powders obtained in the step b are pressed into disks to obtain green bodies.

The green bodies obtained in the step c are enhanced by cold isostatic pressing, and high temperature sintering to obtain ceramics.

The sintered pellets obtained in the step d are polished, coated with a thin layer of non-fluxed Pt paste, and heated to obtain NTC thermistors.

Especially, in the step b, the powders obtained in the step a are calcined at 1000 to 1200° C. for 2 to 6 hours and then ground 6 to 10 hours to obtain Ca₁₋ₓYbₓCeNbWO₈ powder.

Especially, in the step c, the powders obtained in the step b are pressed into disks at a pressure of 5-10 Kg/cm² for 0.2 to 0.5 minutes to obtain green bodies.

Especially, in the step d, the powders obtained in the step c are enhanced by cold isostatic pressing at 200 to 300 MPa for 1 to 3 minutes, the sintering is carried out using a conventional method at 1200 to 1400° C. for 2 to 6 hours to obtain thermistor ceramics.

Preferably, the sintering temperature in the step d is 1350° C., the hold time is 4 h.

Especially, in the step e, the pellets obtained in the step d are polished, coated with a thin layer of 0.1 mm thick non-fluxed Pt paste, and heated at 800 to 900° C. for 30 to 60 minutes, thus obtaining the NTC thermistor ceramics.

The thermistor material of the invention is used to fabricate the high temperature thermistors.

### BRIEF DESCRIPTION OF DRAWINGS

FIG. 1 is the XRD patterns of the ceramic materials.

FIG. 2 is the relationship between Inp and I/T for the NTC thermistors.

### DETAILED DESCRIPTION OF INVENTION

The high-temperature thermistors according to the invention are prepared as follow.

a. The Ca₁₋ₓYbₓCeNbWO₈(0≤x≤0.2) polycrystalline powders are prepared by conventional solid-state reactions.

b. Appropriate amounts of high-purity Yb₂O₃(99.99%), CaCO₃(99%), CeO₂(99.99%), Nb₂O₅(99.99%), and WO₃(99.99%) are well mixed using an agate mortar for 6 to 8 hours to obtain mixed powder.

c. The mixed powders obtained in the step b are calcined at 1000° C. to 1200° C. for 2 to 6 hours and then ground 6 to 10 hours to obtain Ca₁₋ₓYbₓCeNbWO₈ powder.

d. The calcined powders obtained in the step c are pressed into disks at a pressure of 5-10 Kg/cm²for 0.2 to 0.5 minutes. Cold isostatic pressing at 200 to 300 MPa for 1 to 3 minutes is used to enhance their green densities. The sintering is carried out using a conventional method at 1200 to 1400° C. for 2 to 6 hours to obtain thermistor ceramics.

e. For the characterization of electrical properties, the sintered pellets obtained in the step d are polished, coated with a thin layer of 0.1 mm thick non-fluxed Pt paste, and heated at 800 to 900° C. for 30 to 60 minutes. Then the thermistor ceramics composed of Yb₂O₃ doped Ca₁₋ₓYbₓCeNbWO₈ can be obtained. The temperature range of these thermistor materials is 25-800° C., the B_{300° C./600° C.} constant is in the range of 6465K-6732K. The resistivity at 25° C. is in the range of 4.06×10⁷ Ω.cm-8.63×10⁷ Ω.cm.

### Example 1

According to the composition of Ca_{0.95}Yb_{0.05}CeNbWO₈, the raw materials of CaCO₃, CeO₂, Nb₂O₅, WO₃ and Yb₂O₃ are respectively weighted and put into an agate mortar to mix and grind for 6 hours.

The mixed powders obtained in the step a are calcined at 1200° C. for 2 hours and then ground 6 hours to obtain Ca_{0.95}Yb_{0.05}CeNbWO₈ powder.

The calcined powders obtained in the step b are pressed into disks at a pressure of 10 Kg/cm² for 0.2 minutes.

The disks obtained in the step c are enhanced by cold isostatic pressing at 200 MPa for 3 minutes. The sintering is carried out using a conventional method at 1400° C. for 2 hours to obtain thermistor ceramics.

For the characterization of electrical properties, the sintered pellets obtained in the step d are polished, coated with a thin layer of 0.1 mm thick non-fluxed Pt paste, and heated at 900° C. for 30 min. Then the thermistor composed of Yb₂O₃ doped Ca_{0.95}Yb_{0.05}CeNbWO₈ can be obtained. The material constant is B_{300/600° C.} =6465 K, and the resistivity at 25° C. is 4.06×10⁷ Ω.cm.

### Example 2

According to the composition of Ca_{0.9}Yb_{0.1}CeNbWO₈, the raw materials of CaCO₃, CeO₂, Nb₂O₅, WO₃ and Yb₂O₃ are respectively weighted and put into an agate mortar to mix and grind for 8 hours.

The mixed powders obtained in the step a are calcined at 1100° C. for 4 hours and then ground 4 hours to obtain Ca_{0.9}Yb_{0.1}CeNbWO₈ powder.

The calcined powders obtained in the step b are pressed into disks at a pressure of 5 Kg/cm² for 0.5 minutes.

The disks obtained in the step c are enhanced by cold isostatic pressing at 250 MPa for 2 minutes. The sintering is carried out using a conventional method at 1300° C. for 4 hours to obtain thermistor ceramics.

For the characterization of electrical properties, the sintered pellets obtained in the step d are polished, coated with a thin layer of 0.1 mm thick non-fluxed Pt paste, and heated at 900° C. for 30 min. Then the thermistor composed of Yb₂O₃ doped Ca_{0.9}Yb_{0.1}CeNbWO₈ can be obtained. The material constant is B_{300/600° C.} =6470 K, and the resistivity at 25° C. is 4.39×10⁷ Ω.cm.

### Example 3

According to the composition of Ca_{0.85}Yb_{0.15}CeNbWO₈, the raw materials of CaCO₃, CeO₂, Nb₂O₅, WO₃ and Yb₂O₃ are respectively weighted and put into an agate mortar to mix and grind for 8 hours.

The mixed powders obtained in the step a are calcined at 1000° C. for 6 hours and then ground 10 hours to obtain Ca_{0.85}Yb_{0.15}CeNbWO₈ powder.

The calcined powders obtained in the step b are pressed into disks at a pressure of 8 Kg/cm² for 0.3 minutes.

The disks obtained in the step c are enhanced by cold isostatic pressing at 200 MPa for 3 minutes. The sintering is carried out using a conventional method at 1200° C. for 6 hours to obtain thermistor ceramics.

For the characterization of electrical properties, the sintered pellets obtained in the step d are polished, coated with a thin layer of 0.1 mm thick non-fluxed Pt paste, and heated at 900° C. for 30 min. Then the thermistor composed of Yb₂O₃ doped Ca_{0.85}Yb_{0.15}CeNbWO₈ can be obtained. The material constant is B_{300/600° C.} =6580 K, and the resistivity at 25° C. is 6.33×10⁷ Ω.cm.

### Example 4

According to the composition of Ca_{0.8}Yb_{0.2}CeNbWO₈, the raw materials of CaCO₃, CeO₂, Nb₂O₅, WO₃ and Yb₂O₃ are respectively weighted and put into an agate mortar to mix and grind for 8 hours.

The mixed powders obtained in the step a are calcined at 1100° C. for 3 hours and then ground 8 hours to obtain Ca_{0.8}Yb_{0.2}CeNbWO₈ powder.

The calcined powders obtained in the step b are pressed into disks at a pressure of 10 Kg/cm² for 0.5 minutes.

The disks obtained in the step c are enhanced by cold isostatic pressing at 300 MPa for 3 minutes. The sintering is carried out using a conventional method at 1350° C. for 4 hours to obtain thermistor ceramics.

For the characterization of electrical properties, the sintered pellets obtained in the step d are polished, coated with a thin layer of 0.1 mm thick non-fluxed Pt paste, and heated at 900° C. for 30 min. Then the thermistor composed of Yb₂O₃ doped Ca_{0.8}Yb_{0.2}CeNbWO₈ can be obtained. The material constant is B_{300/600° C.} =6732 K, and the resistivity at 25° C. is 8.63×10⁷ Ω.cm.

### Contrasting Example 1

The Contrasting example 1 and example 4 have the same preparation method, the difference is as follows: x=0, the material constant is B_{300/600 C.} =6707 K, and the resistivity at 25° C. is 4.28×10⁷ Ω.cm.

Drawing Illustration

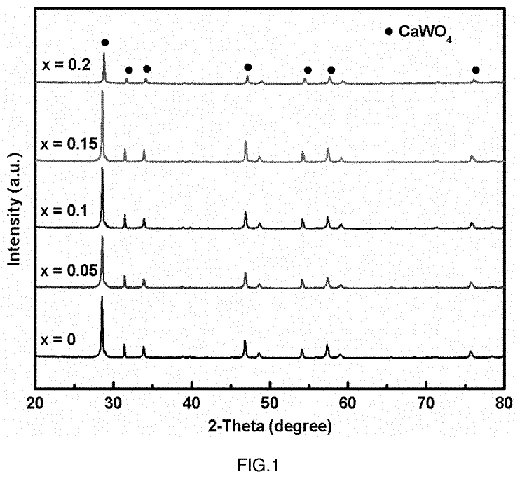

XRD patterns of the ceramic materials are shown in FIG. 1. It can be seen that the structure of as-sintered ceramics is single scheelite structure, and no secondary phase.

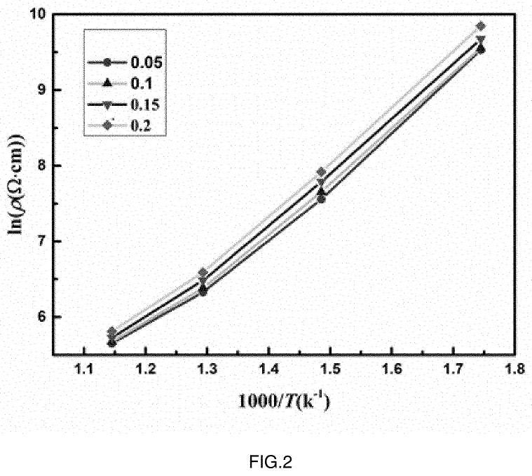

Using the method of example 4, the relationship between Inp and I/T for the NTC thermistors is shown in FIG. 2. The thermistor material according to the invention has a good thermostability and significant negative temperature coefficient (NTC) characteristic in the temperature range of 25° C. to 800° C., could be used as a potential for fabricating high-temperature thermistor sensors.

What is claimed is:

1. A Yb³⁺-doped high temperature thermistor ceramic material is a composite oxide that comprises Ca, Yb, Ce, W and Nb; wherein the thermistor material is prepared by CaCO₃, CeO₂, Nb₂O₅, WO₃ and Yb₂O₃.

2. The Yb³⁺-doped high temperature thermistor material according to claim 1, wherein the thermistor material has a scheelite structure having chemical formula shown as Ca₁₋ₓYbₓCeNbWO₈, wherein 0<x≤0.2.

3. The Yb³⁺-doped high temperature thermistor material according to claim 1, wherein the thermistor material shows a significant negative temperature coefficient (NTC) characteristic in the temperature range of 25° C. to 800° C.

4. A process for preparing the Yb³⁺-doped high temperature thermistor material according to claim 2 comprises the following steps:
a. weigh, mix and grind CaCO₃, CeO₂, Nb₂O₅, WO₃ and Yb₂O₃ based on the chemical formula, Ca₁₋ₓYbₓCeNbWO₈; obtain a mixing powder;
b. calcine the mixing powder, and further grind to obtain Ca₁₋ₓYbₓCeNbWO₈ powder;
c. compress the Ca₁₋ₓYbₓCeNbWO₈ powder into a disk;
d. cold isostatic press the disk, sinter the disk at high temperature to obtain a high-temperature thermistor ceramic after cooling to room temperature;
e. coat the high-temperature thermistor ceramic with platinum paste electrode on both sides, and then anneal to obtain NTC thermistor ceramics after cooling to room temperature.

5. The process according to claim 4, wherein in step b, calcine the mixing powder at 1000 to 1200° C. for 2 to 6 hours, and then grind for 6 to 10 hours to obtain the Ca₁₋ₓYbₓCeNbWO₈ powder.

6. The process according to claim 4, wherein in step c, compress the Ca₁₋ₓYbₓCeNbWO₈powder at a pressure of 5-10 Kg/cm² for 0.2 to 0.5 minutes to obtain the disk.

7. The process according to claim 4, wherein in step d, cold isostatic press the disk at 200 to 300 MPa for 1 to 3 minutes, sinter the disk at 1200 to 1400° C. for 2 to 6 hours to obtain the high-temperature thermistor ceramic.

8. The process according to claim 4, wherein in step e, coat the high-temperature thermistor ceramic with a thin layer non-fluxed Pt paste at 800 to 900° C. for 30 to 60 minutes, thus obtaining the NTC thermistor ceramic.

9. A method for manufacturing high-temperature thermistors with the thermistor material comprising a step of mixing the thermistor material with essential materials of the high-temperature thermistors.
